(19) United States
(12) Patent Application Publication
(10) Pub. No.: US 2016/0300301 A1
(43) Pub. Date: Oct. 13, 2016

(54) METHODS AND SYSTEMS FOR FACILITATING BUSINESS TRANSACTIONS

(71) Applicant: Yu CHEN, Irvine, CA (US)

(72) Inventor: Yu CHEN, Irvine, CA (US)

(21) Appl. No.: 14/685,333

(22) Filed: Apr. 13, 2015

(51) Int. Cl. G06Q 40/02

(52) U.S. Cl. CPC G06Q 40/025

(57) ABSTRACT

Systems and methods for forwarding product specifications and/or price quotes during an online chat session are disclosed. Prospective borrowers visit the online loan exchange and enter loan scenario information. The loan exchange searches the database for compatible loan quotes, and retrieves a list of competitive loan quotes which is then sent to the borrower. The prospective borrower selects a loan quote, and is offered to enter into a chat session with the loan agent. The loan agent receives a request to enter into the chat session with the prospective borrower, and automatically or manually receives both the loan scenario and/or the loan quotation. Systems and methods for escrow and title agents to post their services and fees on the loan exchange are also disclosed. The loan agent develops matching rules to select compatible services as part of the loan quotation.

### BACKGROUND OF THE INVENTION

1. Field of the Invention

The present invention relates in general to systems and methods for facilitating business transactions. More particularly, the invention is directed to systems and methods for facilitating transactions between customers and businesses.

2. Description of the Related Art

Many mortgage and financial services providers offer their services to prospective customers over the Internet. However, many conventional approaches require prospective customers to visit multiple websites, make comparisons manually, and place phone calls with agents to complete the transaction.

Accordingly, a need exists to facilitate and streamline the process of matching borrowers to loan agents.

### SUMMARY OF THE INVENTION

In the first aspect, a machine implemented method for carrying forward information in a chat session is disclosed. The method comprises receiving via a first user computing device a list of parameters describing a desired business offering from a first user, initiating a chat session between the first user computing device and a second user computing device, and forwarding the list of parameters and/or business offering(s) to the second user computing device.

In a first preferred embodiment, the method further comprises storing the list of parameters and/or business offering(s) in the second user computing device. The list of parameters preferably comprises at least four features. The list of parameters preferably describes a loan scenario for a loan. The list of parameters preferably describes a desired vehicle for purchase. The list of parameters preferably describes a desired insurance package. The list of parameters preferably describes information for obtaining a credit card offering. The list of parameters preferably describes information describing a real estate transaction.

In a second aspect, a machine readable non-transitory medium storing executable program instructions which when executed cause a data processing system to perform a method is disclosed. The method comprises receiving a loan scenario via a network by at least one processor from a first computing device, selecting a list of compatible loan quotes based on the loan scenario by the at least one processor, transmitting the list of the compatible loan quotes from the at least one processor to the first computing device, and displaying the list of compatible loan quotes on the first computing device. The method further comprises receiving the selected loan quote by an input on the first computing device, and facilitating a chat session between the first computing device and a second computing device.

In a second preferred embodiment, the method further comprises automatically or manually forwarding the loan scenario and/or the selected loan quote to the second computing device. The method preferably further comprises storing the loan scenario and/or the selected loan quote on the second computing device. The method preferably further comprises providing a pre-determined message and/or a conversation from the second computing device to the first computing device. The method preferably further comprises storing a pre-determined message on the second computing device. The loan quotes preferably comprise a mortgage interest rate trend customized for each quote. The method preferably further comprises receiving from the second computing device a criteria for the lender-paid compensation and the borrower-paid compensation. The method preferably further comprises comparing the criteria to pre-determined rules. The method preferably further comprises receiving from the second computing device, one or more loan quotes to be made available to prospective borrowers in response to proposed loan scenarios. The loan scenario and/or loan quote is preferably for a real estate loan.

In a third aspect, a system for electronically facilitating real estate transactions is disclosed. The system comprises a network, a first computing device, a second computing device, and at least one processor operably coupled to the network. The at least one processor is configured to: receive a loan scenario, select a list of compatible loan quotes based on the loan scenario by the at least one processor, and transmit the list of the compatible loan quotes from the at least one processor to a first computing device. The first computing device is configured to display the list of compatible loan quotes, receive the selected loan quote by an input on the first computing device, and facilitate a chat session between the first computing device and the second computing device.

In a third preferred embodiment, the at least one processor is further configured to automatically or manually forward the loan scenario and/or the selected loan quote to the second computing device.

In a fourth aspect, a machine implemented method for facilitating business transactions, is disclosed. The method comprises receiving business offerings from a business via a business computing device, storing the business offerings in a database operationally coupled with at least one processor, retrieving the business offerings from the database, and transmitting the business offerings to a second computing device via a network. The method further comprise receiving matching rules from the second computing device, receiving a request for goods or services, and selecting a compatible business offering based on the business offerings, the request for goods or services, and the matching rules.

In a fourth preferred embodiment, the matching rules requires the selection of the compatible business offering based on a lowest overall price of the business offering. The matching rules preferably require the selection of the compatible business offering based on a location of the business. The matching rules preferably require the selection of the compatible business offering based on a rating of the business. The method preferably further comprises presenting the compatible business offering as part of a quotation. The business is preferably an escrow agent. The business is preferably a title agent. Request for goods or services preferably comprises a request for price quotations and/or business offerings. The network is preferably the Internet.

In a fifth aspect, a machine readable non-transitory medium storing executable program instructions which when executed cause a data processing system to perform a method is disclosed. The method comprises receiving business offerings from a business via a business computing device, storing the business offerings in a database operationally coupled with at least one processor, retrieving the business offerings from the database, and transmitting the business offerings to a second computing device via a network. The method further comprise receiving matching rules from the second computing device, receiving a request for goods or services, and selecting a compatible business offering based on the business offerings, the request for goods or services, and the matching rules.

In a fifth preferred embodiment, the matching rules requires the selection of the compatible business offering based on a lowest overall price of the business offering. The matching rules preferably require the selection of the compatible business offering based on a location of the business. The matching rules preferably require the selection of the compatible business offering based on a rating of the business. The method preferably further comprises presenting the compatible business offering as part of a quotation. The business is preferably an escrow agent. The business is preferably a title agent. Request for goods or services preferably comprise a request for price quotations and/or business offerings. The network is preferably the Internet.

In a sixth aspect, a system for electronically facilitating business transactions is disclosed. The system comprises a business computing device from a business, a network, a database, and at least one processor operationally coupled to the database. The at least one processor is configured to receive business offerings from the business via the business computing device, store the business offerings in the database, retrieve the business offerings from the database, and transmit the business offerings to a second computing device via a network. The system is further configured to receive matching rules from the second computing device, receive a request for goods or services, and select a compatible business offering based on the business offerings, the request for goods or services, and the matching rules.

In a sixth preferred embodiment, the at least one processor is further configured to present the compatible business offering as part of a quotation.

These and other features and advantages of the invention will become more apparent with a description of preferred embodiments in reference to the associated drawings.

### DESCRIPTION OF THE DRAWINGS

FIG. 1A is a schematic block diagram of chat session between a buyer device and an agent device, where the product specifications and/or business offering(s) are forwarded to the agent device.

FIG. 1B is an exemplary flowchart of a method for carrying forward product specifications and/or business offering(s) during a chat session.

FIG. 1C is a schematic block diagram of a system having a loan exchange website.

FIG. 2 is an exemplary flowchart illustrating a method for a loan exchange facilitating a transaction between a prospective borrower and a loan agent.

FIG. 3 is an exemplary screenshot of a display presented to a borrower summarizing available loan terms.

FIG. 4 is an exemplary screenshot of a display presented to a borrower listing competitive loan quotes from multiple loan agents.

FIG. 5 is an exemplary screenshot of a display presented to a borrower showing a loan summary.

FIG. 6 is an exemplary screenshot of a display presented to a borrower illustrating the borrower initiating a chat session with the loan agent.

FIG. 7 is an exemplary screenshot of a display presented to a loan agent indicating that a prospective borrower has initiated a chat session.

FIG. 8 is an exemplary screenshot of a display presented to the loan agent showing the message sent from the borrower in the chat session.

FIG. 9 is an exemplary screenshot of a display showing a loan scenario.

FIG. 10 is an exemplary screenshot of a contact list.

FIG. 11 is an exemplary screenshot provided to the loan agent showing the loan scenario and the loan quote.

FIG. 12 is an exemplary screenshot of a display presented to a loan agent showing the loan scenario, the loan quote, and the chat session.

FIG. 13 is an exemplary screenshot of a webpage showing the mortgage rate history.

FIG. 14 is an exemplary screenshot of a webpage showing a loan scenario and a chat session window.

FIG. 15 is an exemplary screenshot of a webpage showing the loan quote.

FIG. 16 is an exemplary screenshot of a display showing mortgage information including mortgage interest rate trends.

FIG. 17 is a screenshot of a display showing a user saving a canned reply.

FIG. 18 is a screenshot of a display showing a user retrieving a canned reply.

FIG. 19 is a screenshot of a user adding a new canned reply to the device.

FIG. 20 is an exemplary screenshot of a display listing a directory of chat sessions.

FIG. 21 is an exemplary screenshot of a display showing the loan scenario.

FIG. 22 is an exemplary screenshot of a webpage showing the loan scenario.

FIG. 23 is an exemplary screenshot of a display illustrating the selection of lender paid compensation and borrower paid compensation.

FIG. 24 is an exemplary screenshot of webpage showing a custom rate trend for a particular scenario of a customer.

FIG. 25 is an exemplary screenshot of webpage showing a mortgage rate history associated with the rate trend hyperlink.

FIG. 26 is an exemplary screenshot of a webpage showing a refinance calculator.

FIG. 27 is an exemplary screenshot of a webpage showing a refinance calculator in an embodiment.

FIG. 28 is an exemplary screenshot of a webpage showing a calculator icon having a link to the refinance calculator.

FIG. 29 is an exemplary screenshot of a webpage showing a refinance calculator in an embodiment.

FIG. 30 is an exemplary screenshot of a webpage showing the title and escrow fee rate schedule paired with the rate quotes.

FIG. 31 is a flowchart of the method for selecting lender paid compensation and borrower paid compensation.

FIG. 32 is a flowchart showing the method for loan agent selecting specific escrow and title agents.

FIG. 33 is a schematic block diagram of a mobile device.

### DETAILED DESCRIPTION OF THE PREFERRED EMBODIMENTS

The following preferred embodiments are directed to a machine implemented method for carrying forward information in a chat session. A first user computing device receives a list of parameters describing a desired business offering from a prospective purchaser (i.e., a first user). A chat session is initiated between the purchaser's computing device and an agent's or seller's (i.e., a second user) computing device. The list of parameters is forwarded to the second user computing device. In one or more embodiments, the list of parameters is stored in the agent's computing device. In one or more embodiments, the list of parameters comprises at least four features.

In one or more embodiments, the Chat function that carries over the specifications of product/service would preferably cover loans (mortgage, car, student loan, etc.), insurance, real estate sales, credit card offers, etc.

Many types of business transactions are contemplated in one or more embodiments especially where the desired product carries a high number of specifications or parameters. For example, a consumer may be looking for a mortgage, where the list of parameters to be carried over includes the loan amount, purchase price or home value, and loan purpose. In another example, the consumer may be looking for a car, where the list of parameters may include the make, model, year, color, body style and other options. The purchaser may be shopping for homeowner insurance, where the list of parameters may include the location, house type, policy limits, special coverages, etc. The transaction involving car insurance may have a list of parameters including location, make, identity of drivers, policy limits and model. A transaction for life insurance may include a list of parameters of insurance amount, pre-existing health conditions, type of life insurance, and age. A consumer looking for health insurance may have a list of parameters including age, sex, caregivers who must be in the network, etc. A buyer interested in real estate sales may have a list of parameters including the number of bedrooms and the square footage range. A consumer shopping for credit card offers may have a list of parameters including the credit score range.

One or more embodiments are directed to loan exchange systems and methods. In one or more embodiments, an online loan exchange facilitates the mortgage brokerage process by connecting prospective consumers (i.e., borrowers) to loan agents. Loan agents establish accounts with the loan exchange system and provide loan quotations which are stored in the loan exchange database. Prospective borrowers visit the online loan exchange and enter loan scenario information describing their lending needs. The loan exchange receives this loan scenario, searches the database for loan quotes that match the loan scenario requirements, and retrieves a list of competitive loan quotes from multiple loan agents which is then sent to the borrower. The loan scenario includes at least the following loan parameters: loan amount, purchase price or home value, loan purpose in one or more embodiments. In a preferred embodiment, the loan quote automatically displays the trend of the daily mortgage interest rate by comparing it to that of the previous day after logging in—higher, lower, or unchanged. An embodiment may also generate a custom rate trend graph based on the loan scenario. In one or more embodiments, the chat type may present the rate and corresponding net closing cost. The prospective borrower selects a loan quote, and is offered an opportunity to enter into a chat session with the loan agent. The loan agent receives a request to enter into the chat session with the prospective borrower, and receives both the loan scenario and the selected quotation, sent automatically or manually by the prospective borrower. Within minutes of visiting the loan exchange website, the prospective borrower is matched and connected to a loan agent. When a prospective borrower user manually initiates a chat request to the selected loan agent(s), the loan exchange creates a customer profile and saves the associated loan scenario in the loan agent's CRM module in a loan exchange professional app, automatically or by taking a manual action.

In one or more embodiments, the feature of the chat session, with product specifications carried over automatically or manually requested, can be applied to other services or industries where customers would need to provide a number of product specifications in order to get a list of sellers or providers and business offerings. For example, a potential home buyer may enter house searching parameters such as zip code, price range, range of number of bedrooms and bathrooms, range of square feet, and so forth to obtain a list of houses listed for sale and their listing agents. When this potential home buyer contacts the listing agent via such a chat function, the search parameters, not just the address of the selected house listing, will be sent to the listing agent in the chat, automatically or by taking a manual action.

In one or more embodiments, the chat feature can be used to send competitive business offerings for any product (not only loans) where (1) the scenario/parameters do not have to be repeated, and (2) each offering is tied to a particular seller or service provider.

In one or more embodiments, the loan exchange may provide useful website tools or applications (“apps”) for borrowers and loan agents use on their smart phone or via a website. For example, the loan exchange may provide a refinance calculator to determine the savings and costs for refinancing to a new mortgage. A refinance loan scenario may provide links to a refinance calculator to quickly calculate how much the total interest savings would be if refinanced to a different rate and maintain the same monthly principal and interest (“P&I”) payment.

In one or more embodiments, a software application, or simply app, running on the loan agent computing device, such as a smartphone or other mobile devices, may provide pre-determined messages or “canned” replies to the borrower during the chat session. A user may conveniently add a canned reply by tapping and holding a chat session message. The loan agent can also save a chat message as a Canned Message for later retrieval. In one or more embodiments, the loan exchange may enable escrow or title agents an opportunity to list their services and fees.

In one or more embodiments, the loan exchange may automatically select the compensation model to quote prospective borrowers based on a pre-configured preference by loan agent. The loan agent can pre-configure the Lender-Paid Compensation (“LPC”) and Borrower-Paid Compensation (“BPC”) levels. For lenders that allow LPC and BPC to be different, the quotes to prospective borrowers can be based on the following algorithms the loan agent would pre-configure the lowest rate and lowest net closing cost for borrower, or the higher margin for loan agent.

In one or more embodiments, the loan exchange may offer tools to enable escrow or title agents to input their fee schedule for both purchase and refinance loans. The loan agent can select the fee schedule of certain title/escrow agents to pair with their quotes based on rules set by loan agent. For example, the matching rules may require that quotes are paired with title/escrow agents that will have the lowest overall price, paired with title/escrow agents that are closest in distance based on the zip code provided in the loan scenario, or are paired with title/escrow agents that have the highest rating.

As described herein and as is commonly known in the art, a loan scenario includes information of the type of loan the borrower is researching, and may include the purpose of the loan (ex. refinance, home purchase), the home value, the loan amount, the credit score, location of the property, occupancy, description of the property, number of units, and loan type, for example. A loan quote is an offer of a loan from a loan agent to a prospective borrower and may include the lender, the mortgage rate, the annual percentage rate (“APR”), the term of the program, monthly payments, and costs, for example. The word facilitate means to make a process easier or less difficult, such as by streamlining the process for borrowers to find loans or by enabling escrow or title agents to have their services matched to loan quotes.

As described herein and as is commonly known in the art, chat sessions, or online chat, generally refers to communication between two or more parties over the Internet in the form of real-time text messages sent from the sender to the receiver. Embodiments described herein refer to chat sessions; however, it shall be understood that other forms of communication, including, but not limited to, audio, video, telephonic, messaging using social media, and teleconferencing, are contemplated in one or more embodiments. Reference made herein to a smart phones or a mobile device is for illustration purposes only and shall not be deemed limiting. Mobile device may be any electronic computing device, including handheld computers, smart phones, tablets, laptop computers, smart devices, GPS navigation units, or personal digital assistants, for example. Embodiments depicted herein may suggest direct connections between computing devices and processors; however, it shall be understood that a network such as the Internet is employed to route communication paths within the system of computing devices, processors, and databases in one or more embodiments.

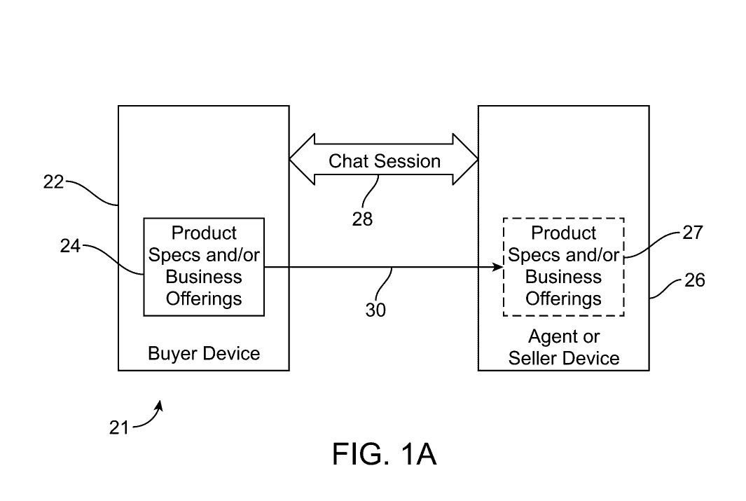

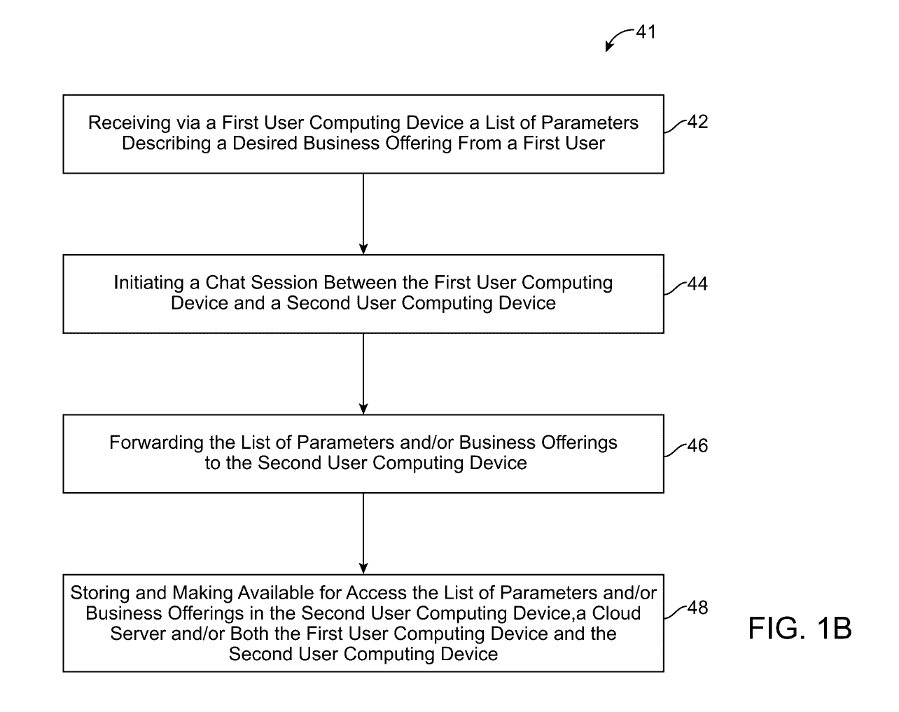

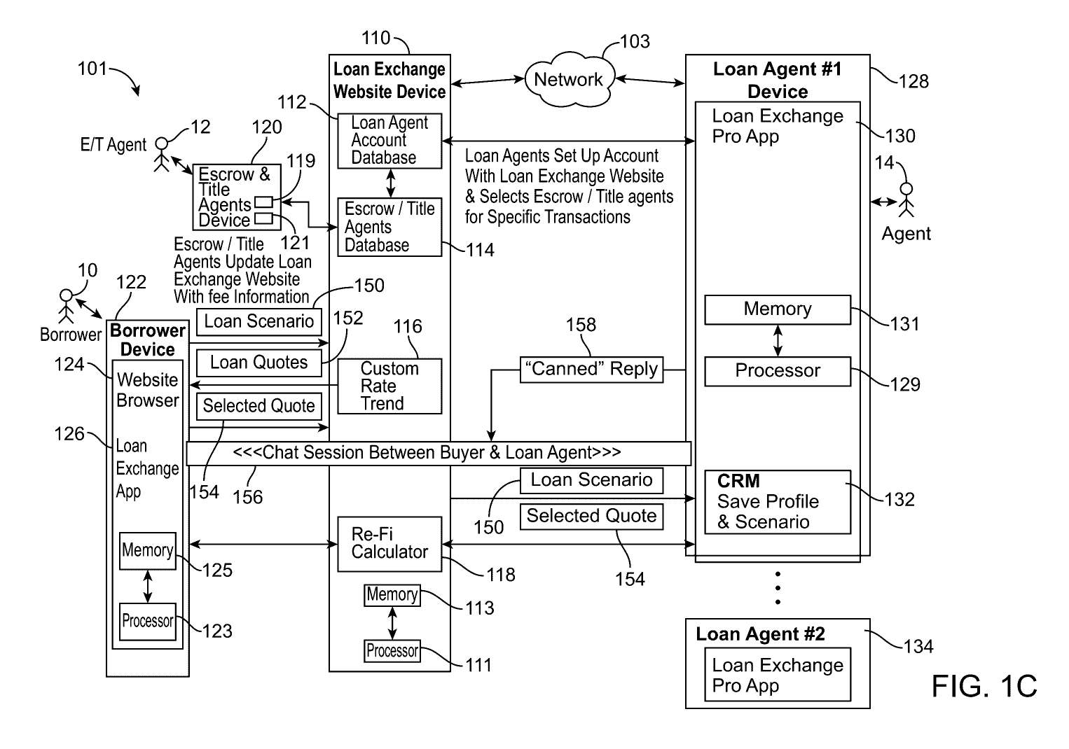

FIG. 1A is a schematic block diagram of a system 21 having a chat session 28 between a buyer device 22 and an agent device 26, where the product specifications 24 (i.e., the list of parameters) and/or business offerings are forwarded to the agent device. FIG. 1B is an exemplary flowchart of a method 41 for carrying forward product specifications during a chat session. A buyer's (i.e., a first user) computing device 22 receives product specifications 24 (i.e., a list of parameters) describing a desired business offering from a prospective purchaser (i.e., a first user) (step 42). A chat session 28 is initiated between the purchaser's computing device 22 and an agent's or seller's (i.e., a second user) computing device 26 (step 44). The product specifications or list of parameters and/or business offerings 24 is forwarded to the second user computing device (step 46). In one or more embodiments, the list of parameters is stored in the agent's computing device 26 (step 48). In one or more embodiments, the list of parameters comprises at least four features. As shown in FIG. 1A, the product specifications or list of parameters and/or business offerings are received by the buyer device in memory 24, are transported via pathway 30, and is received and stored in memory 27 of the agent's computing device 26, the cloud and/or the both the First User Computing Device and Second User Computing Device.

The feature of the chat session 28, with product specifications and/or business offerings automatically carried over or manually requested, can be applied to other services or industries where customers would need to provide a number of product specifications in order to get a list of sellers or providers and business offerings.

In one or more embodiments, the product specifications or list of parameters may have a high number of features to be carried over from one device to another device. In one or more embodiments, the product specifications may comprise four or more features.

For example, a potential home buyer may enter a list of house search parameters including zip code, price range, range of number of bedrooms and bathrooms, range of square feet, and so forth to obtain a list of houses listed for sale and their listing agents. When this potential home buyer contacts the listing agent via such a chat function, the search parameters, not just the address of the selected house listing, will be sent to the listing agent automatically in the chat, automatically or by taking a manual action. Likewise, a consumer may be looking for a mortgage, where the list of parameters to be carried over includes the loan amount, purchase price or home value, and loan purpose.

The set of search parameters and/or business offering(s) are not only carried over in the chat with the selling agent, but also remain stored and available for access throughout the entirety of the chat with said agent. Therefore, anytime the consumer or the selling agent resumes chatting with respect to the desired business offering, the same set of parameters and business offering(s) are stored and available for reference by either the consumer or the selling agent. This eliminates having to repeat any parameters by either party.

The chat feature with the forwarding of information may also be applied to other transactions. For example, the consumer may be looking for a car, where the list of parameters may include the make, model, year, color, body style and other options. The purchaser may be shopping for home owner insurance, where the list of parameters may include the location, house type, policy limits, special coverages, etc. The transaction involving car insurance may have a list of parameters including location, make, identity of drivers, policy limits and model. A transaction for life insurance may include a list of parameters of insurance amount, pre-existing health conditions, type of life insurance, and age. A consumer looking for health insurance may have a list of parameters including age, sex, caregivers who must be in the network, etc. A consumer shopping for credit card offers may have a list of parameters including the credit score range. All of the above examples may also include one or more business offerings from service providers based on the list of parameters.

FIG. 1C is a schematic block diagram of a system 101 for facilitating real estate transactions involving a borrower 10, a loan exchange website device 110, a loan agent 14, and escrow or title agents 12. In one or more embodiments, the system 101 comprises a network 103, a loan exchange website device 110 having at least one processor 111 operably coupled to a memory or database 113, a borrower computing device 122 (i.e., a first computing device) having a processor 123 operably coupled to a memory 125, and a loan agent device 128 (i.e., a second computing device) having a processor 129 operably connected to a memory 131. In one or more embodiments, the system may further comprise an escrow or title agent device 120 (i.e., a business computing device) having a processor 121 operably coupled to a memory 119. The loan exchange website device 110 may act as an intermediary between the borrower device 122 and the loan agent device 128, as well as between the escrow and title agent device 120 and the loan agent device 128.

In one or more embodiments, one or more of the memories 125, 113, 131, and 119 may comprise machine readable non-transitory medium storing executable program instructions which when executed cause the data processing system to perform one or more of the methods described herein.

The process begins with loan agents 14, employing their loan agent devices 128 and 134, establishing accounts on the loan exchange website device 110 in a loan agent account database 112 for example. The loan agents 14 establish loan quotes which are responsive to anticipated loan scenarios they may receive from prospective borrowers 10. In an embodiment, the loan exchange website device 110 may receive from the loan agent 14 a criteria for the lender paid compensation and the borrower paid compensation. The loan exchange website device 110 may compare the criteria to pre-determined rules.

After the loan agents 14 establish accounts with the loan exchange website device, prospective borrowers 10 may visit the loan exchange website to obtain quotes for loans and other services. In one or more embodiments, the borrower computing device 122 may be a smartphone running a loan exchange app 126, or may be a computing device running a browser 124. The loan exchange website device 110 may comprise a computer, a cluster of computers, servers, databases, or cloud servers. The loan exchange website device 110 has one or more processors 111, a refinance (“Re-Fi”) calculator, a custom rate trend module 116, an escrow/title agent database 114, and a loan agent account database 112. In one or more embodiments, the escrow/title agent device 120 may be a computing device or a smartphone. In one or more embodiments, the loan agent device 128 may be a smartphone running a loan exchange professional application (“pro app”) 130, or may be a computing device running a browser.

In one or more embodiments, a borrower 10 interacting with a borrower computing device 122 may visit the loan exchange website device 110, the borrower computing device 122 employing a web browser 124 on a computer or a loan exchange app 126 running on a smartphone or mobile computing device. The borrower 10 enters a loan scenario into the device 122, which then transmits the loan scenario 150 to the loan exchange website device 110. One or more processors 111 receive the loan scenario 150, select loan quotes based on the loan scenario, and generates a list of the selected loan quotes. The loan quotes 152 may comprise mortgage interest rate trends. The list of selected loan quotes 152 is then transmitted back to the borrower computing device 122 which presents the list to the borrower 10. The borrower computing device 122 receives the selected quote 154 from the borrower 10, which then transmits the selected quote 154 to the loan exchange website device 110.

In one or more embodiments, the borrower 10 may request to enter into a chat session with the loan agent 14 associated with the selected quote 154. The loan exchange website device 110 may facilitate a chat session 156 between the borrower computing device 122 and the loan agent computing device 128. In an embodiment, the loan exchange website device 110 automatically or manually forwards the loan scenario 150 and/or the selected quote 154 data to the loan agent computing device 128. The loan agent computing device 128 may store the selected loan quote 154 and the loan scenario 154 in a loan agent device 128 in a Customer Relationship Management application 132 (“CRM”) in one or more embodiments.

The loan agent computing device 128 may notify the loan agent 14 of the request for a chat session 156. In one or more embodiments, the loan agent computing device 128 may provide the loan agents 14 with a pre-determined or “canned” message 158 to relay from the loan agent device 128 to the borrower device 122. The pre-determined or “canned” message 158 may be stored on the loan agent device 128 for later use.

In one or more embodiments, the loan agents 14 or prospective borrowers 10, employing their respective devices, are offered access to a refinance calculator 118 running on the loan exchange website device 110.

In one or more embodiments, the system 101 enables businesses to submit their business offerings (i.e., goods and or services offered by a business). The loan exchange website device 110 receives business offerings from a business such as a title or escrow agent via a business computing device 120. The loan exchange website device stores the business offerings in a database 114 operationally coupled with at least one processor 111. The loan exchange website device 110 may then retrieve the business offerings from the database 114, and transmit the business offerings to a second computing device 128 via a network 103. A second computing device, such as the loan agent computing device 128, may receive and transmit matching rules back to the loan exchange website device 110. The website device 110 receives a request for goods or services, such as a request for loan quotations, and selects a compatible business offering based on the business offerings, the request for goods or services, and the matching rules.

In one or more embodiments, escrow and title agents employing their escrow and title computing devices 120 may interact with the escrow/title agent database 114 within the loan exchange website 110 and enter information regarding their services and the fees 140. The loan agent device 128 may interact with the loan exchange website 110 and set up an account in the loan agent account database 112. The loan agent 14 may then review the services and fee information from the escrow/title agents, and establish rules for pairing specific escrow/title agents with the loan quotation based on the loan scenario.

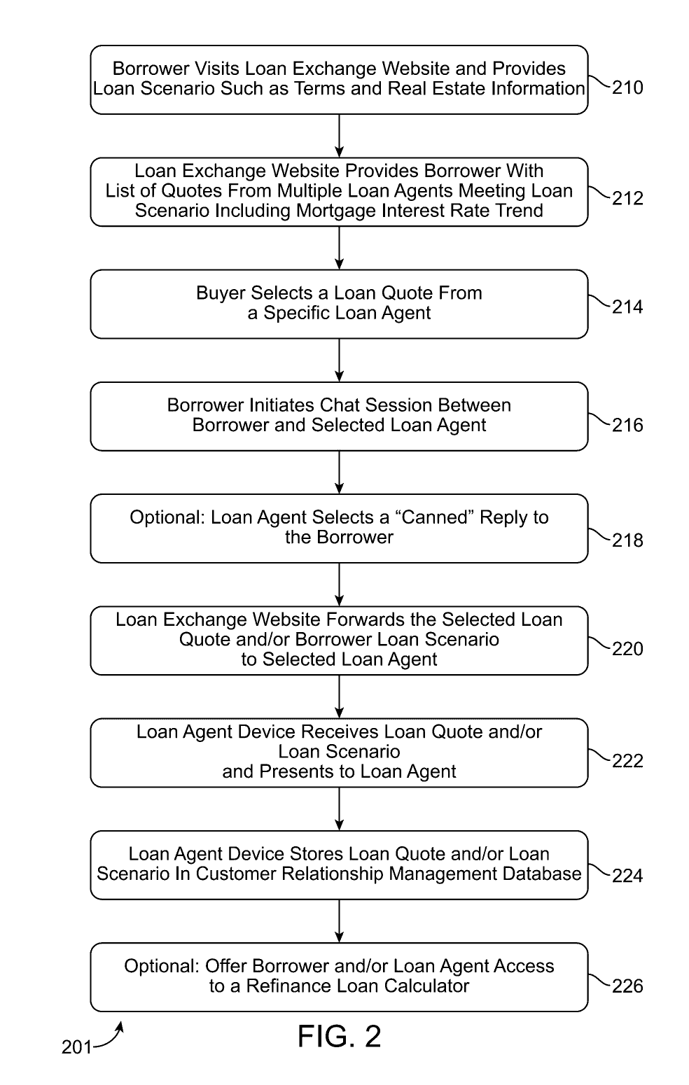

FIG. 2 is an exemplary flowchart illustrating a method 201 for facilitating a loan exchange. In one or more embodiments, the borrower 10, the loan exchange website, and the loan agents 14, employ the borrower computing device 122, the loan exchange website device 110, and the loan agent computing devices 128 respectively. The method 201 begins with a borrower 10 employing the borrower device 122, visiting the loan exchange website running on the loan exchange website device 110. The borrower 10 provides a loan scenario 150 including terms and real estate Information (step 210). The loan exchange website provides the borrower 10 with a list of quotes 152 from multiple loan agents 14 meeting the loan scenario. The loan quote may include an icon indicating the mortgage interest rate trend (step 212). The borrower 10 selects a loan quote 154 from a specific loan agent 14 (step 214). The borrower 10 initiates a chat session 156 between the borrower 10 and the selected loan agent 14 (step 216). Optionally, the loan agent 14 selects a pre-determined or “canned” reply 158 to the borrower 10 (step 218). The loan agent 14 can save any chat conversation text as Canned Reply for future easy retrieval. The loan exchange website device 110 forwards the selected loan quote 154 and/or borrower loan scenario 150 to the selected loan agent 14 (step 220). The loan agent device 128 receives the loan quote 154 and/or loan scenario 150 and presents them to the loan agent 14 (step 222). The loan search parameters will be automatically saved as a loan scenario in the customer record in CRM 132 that can be retrieved later. This will help make the communication between the loan agent 14 and the borrower 10 more efficient (step 224). Optionally, the borrower 10 and/or the loan agent 14 are offered access to a refinance loan calculator 118 (step 226).

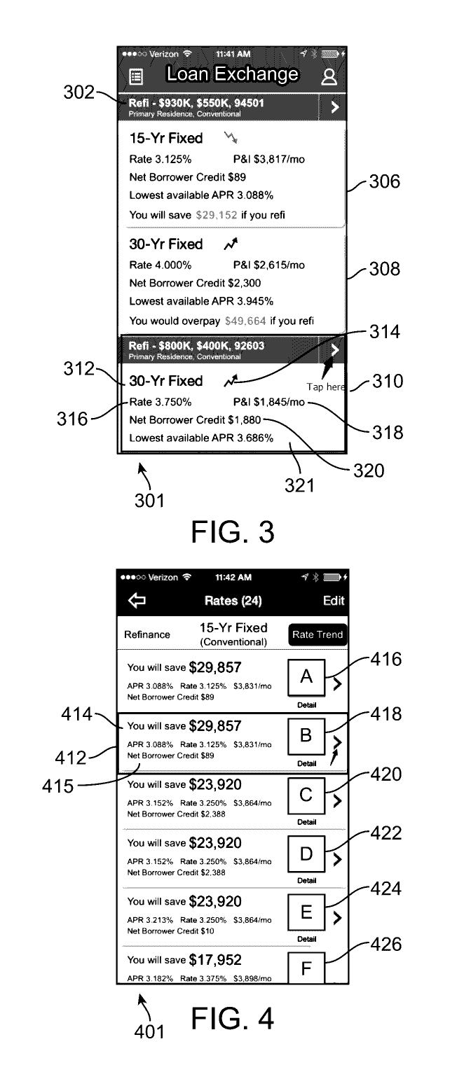

The following screenshots depict the displays seen by the borrower 10 and loan agent 14 during the loan selection process. FIG. 3 is an exemplary screenshot of a display 301 presented to a borrower 10 summarizing available loan terms. The prospective borrower 10 enters loan parameters and starts searching for rates, and then selects the loan agent 14 to contact. The display 301 includes a summary of multiple loans 306, 308, and 310 for a given set of loan criteria 302. The summary 310 includes the term of the loan 312, the mortgage interest rate 316, the principal and interest 318, the net borrower credit 320, and the lowest available APR 321.

FIG. 4 is an exemplary screenshot of a display 401 presented to a borrower 10 listing competitive loan quotes 416, 418, 420, 422, 424, and 426 from multiple loan agents 14. Within the loan quote 418 includes the APR, rate and monthly payment 412, the savings 414, and the Net Borrower credit 415. The borrower 10 then selects a loan quote.

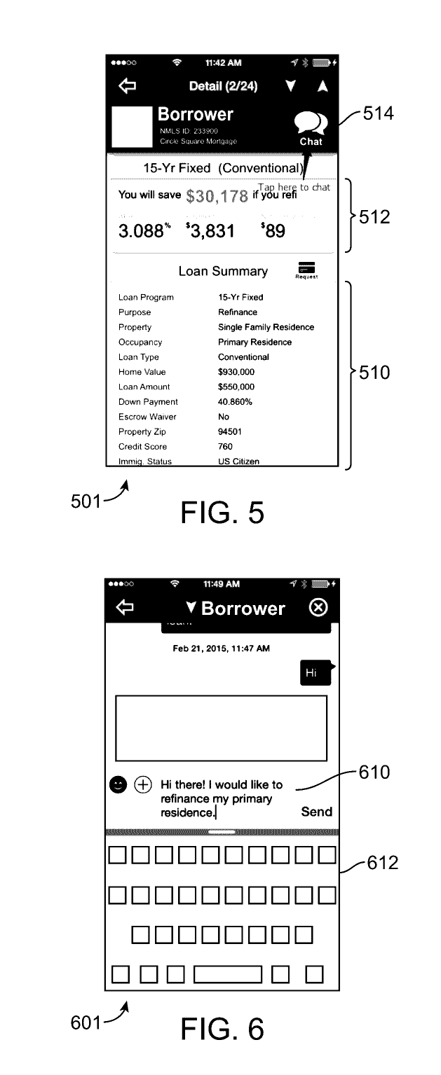

FIG. 5 is an exemplary screenshot of a display 501 presented to a borrower 10 showing the loan summery 510, highlights 512, and an icon 514 which the borrower 10 may select to initiate a chat session with the loan agent 14 associated with the selected loan quote. Once the chat session icon 514 is selected, the borrower 10 will see an exemplary screenshot of a display 601 depicted in FIG. 6. The display 601 comprises a keyboard 612 for entering a chat message 610.

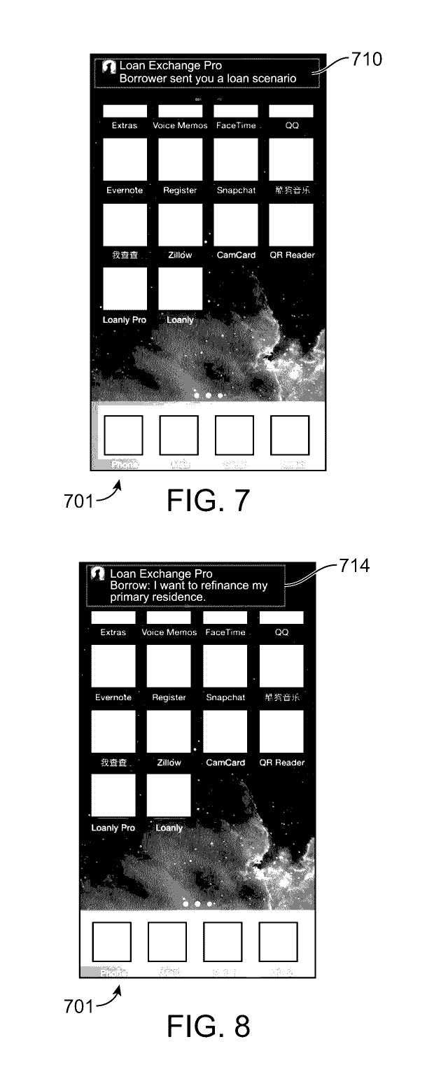

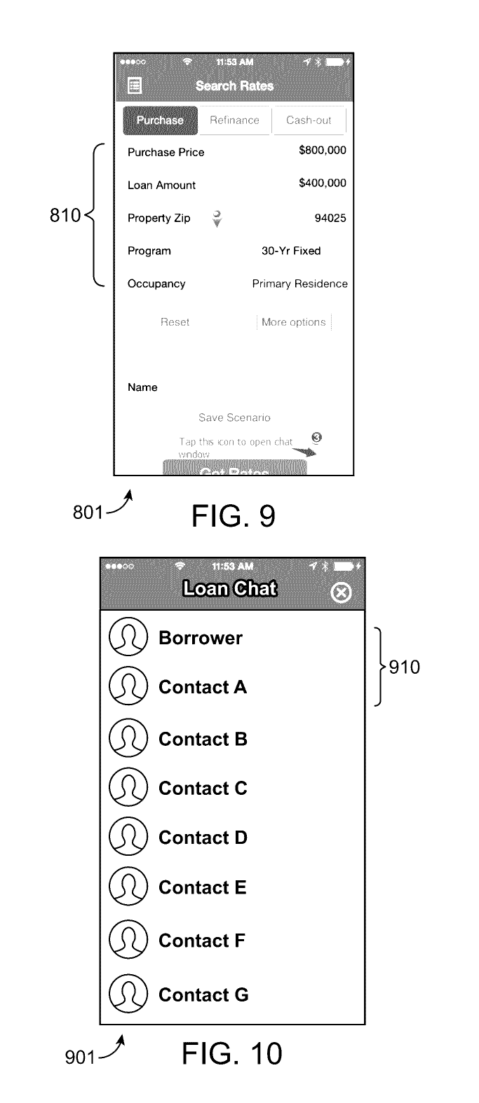

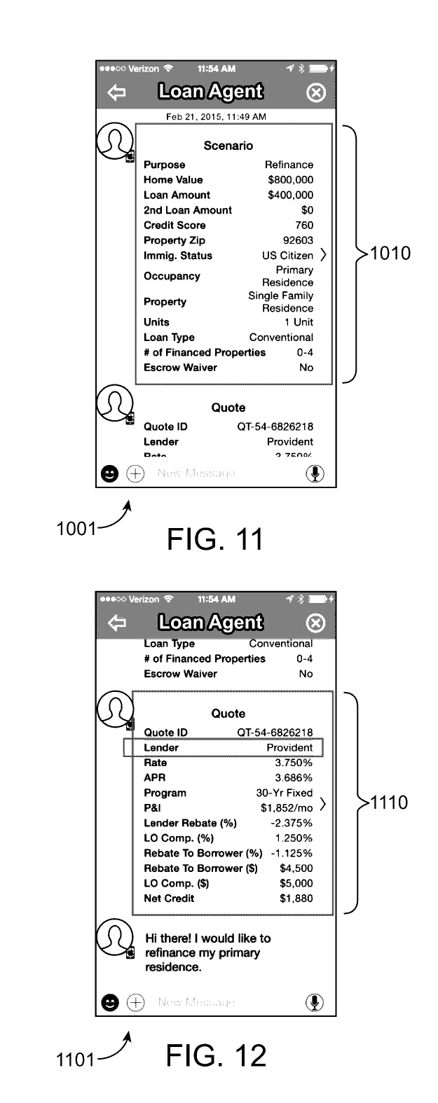

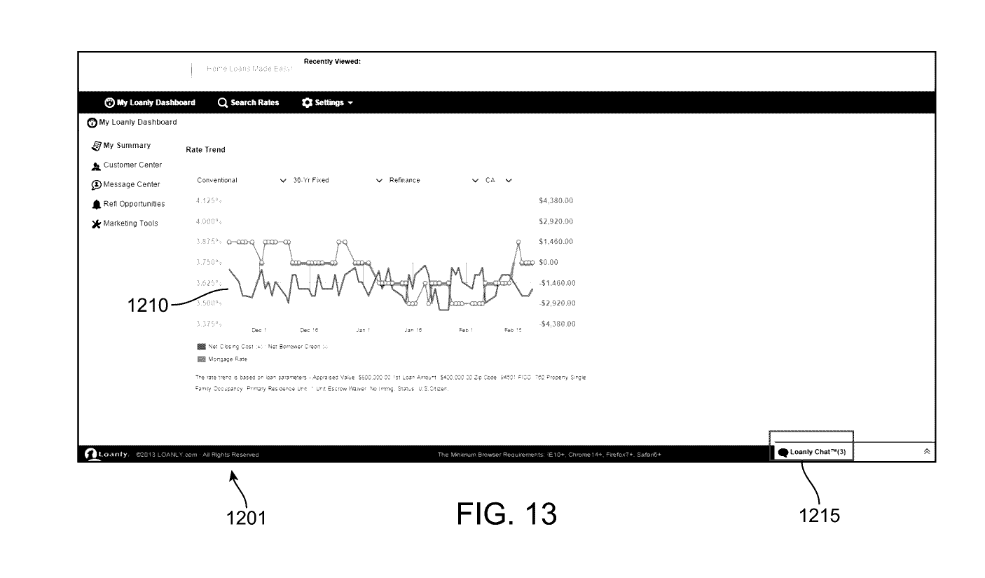

FIG. 7 is an exemplary screenshot of a display 701 presented to a loan agent 14 indicating that a borrower 10 has initiated a chat session. The loan agent 14 receives a notification 710 on his/her loan exchange pro app 130 as depicted in FIG. 1. As shown in FIG. 8, the loan agent 14 then sees the chat session message 714 sent by the prospective borrower 10. Both the loan scenario 150 and the lender/quote 154 selected by the borrower 10 are sent to the loan agent 14. As depicted in FIG. 9, the display 801 presents the borrower's loan data 810. FIG. 10 is an exemplary screenshot showing a display 901 of a contact list, including the icon 910 for the prospective borrower 10 who initiated the ongoing chat session. FIGS. 11 and 12 are screenshots of the displays 1001 and 1101 showing that the loan scenario 1010 and the loan quote 1110 are available on the loan agent device 128.

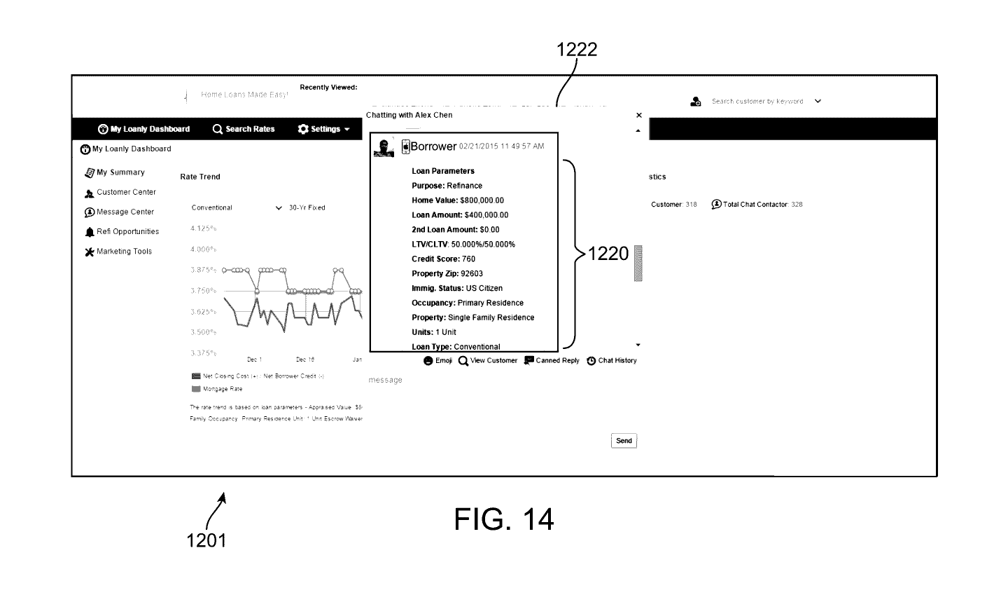

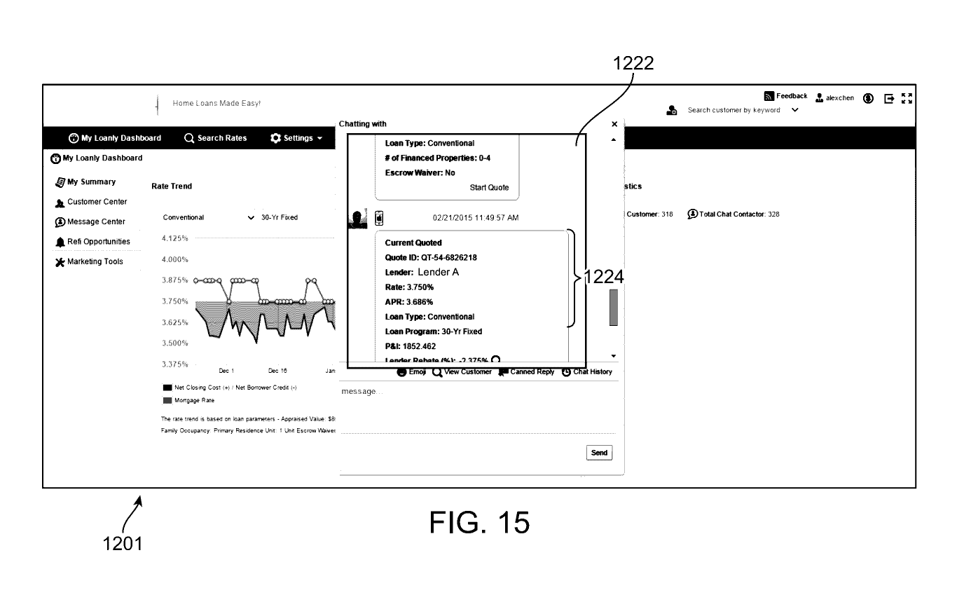

FIG. 13 is a screenshot of a webpage 1201 showing the mortgage rate history 1210 and chat icon 1215 for continuing a chat session. As shown in FIGS. 14 and 15, the chat session window 1222 opens and presents the loan agent 14 with the loan scenario 1220 and the selected loan quote 1224.

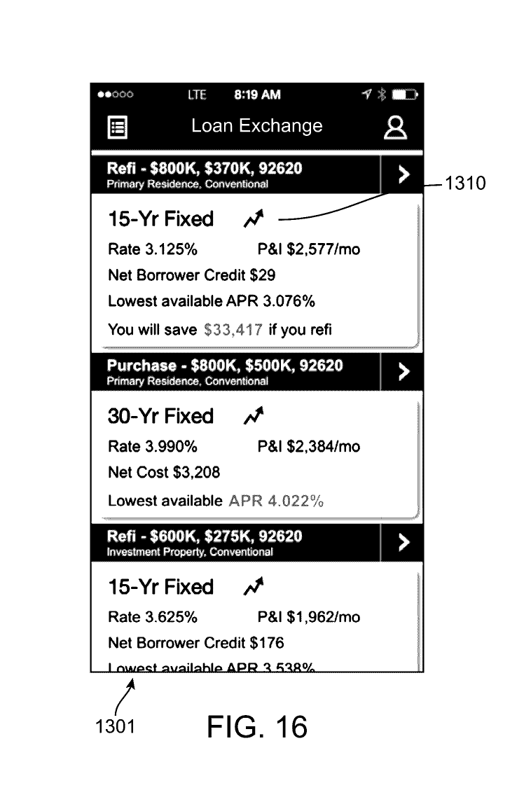

In one or more embodiments, the interest rate trend is displayed. FIG. 16 is an exemplary screenshot of display 1301 showing mortgage information including mortgage interest rate trends 1310 depicted as an upward arrow in red indicating that loan interest rates have increased compared to the previous day for example. A downward green arrow may depict falling interest rates.

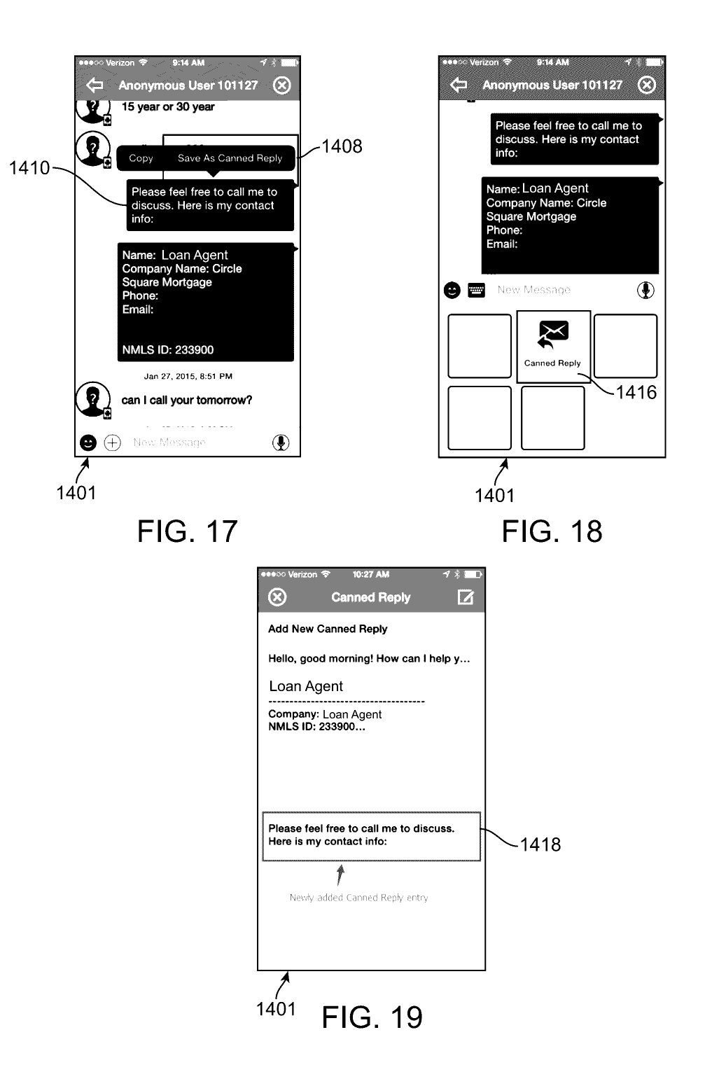

In one or more embodiments, pre-determined or “canned” reply messages may be provided. As shown in FIG. 17, the display 1401 may include a window 1410 for entering a message, and an icon 1408 for saving the entered message as a canned reply. FIG. 18 is a screenshot of a user retrieving a canned reply by selecting a canned reply icon 1416. As shown in FIG. 19, the canned reply 1410 stored in FIG. 17 is reproduced as a message 1418.

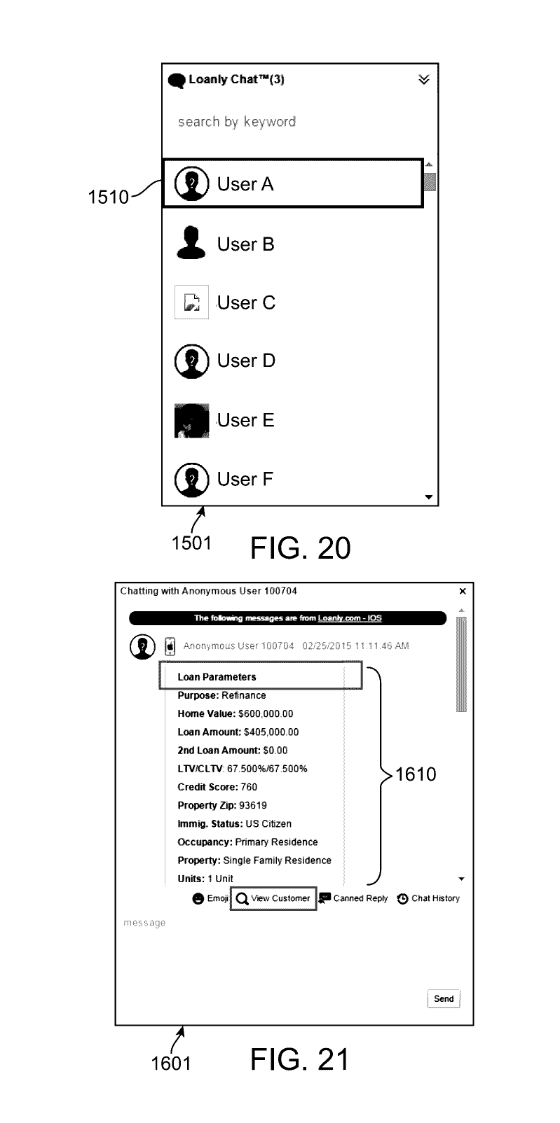

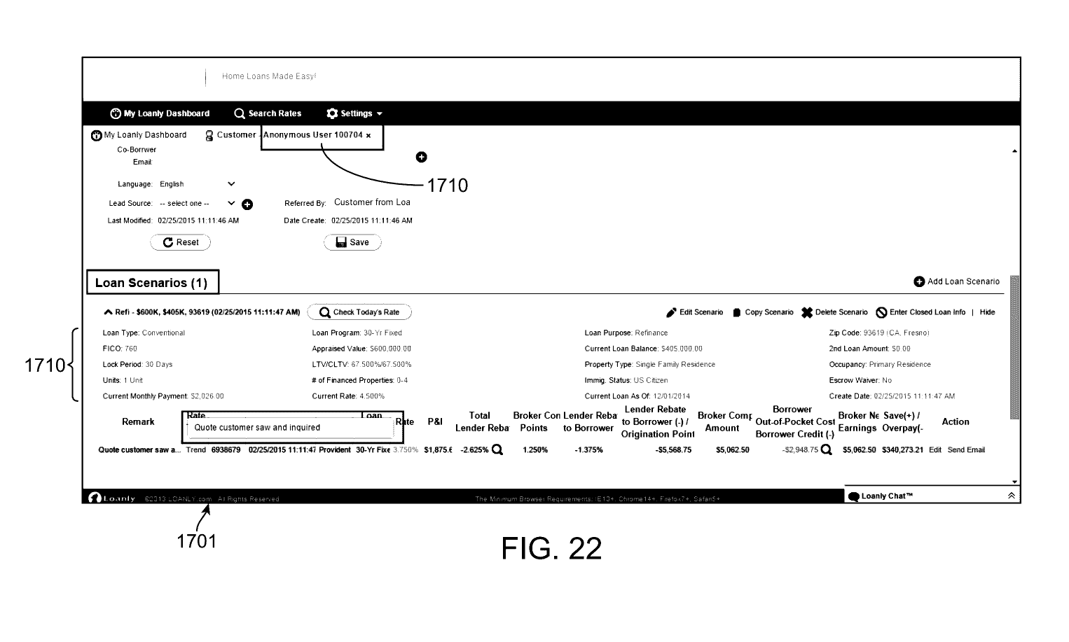

As shown in FIGS. 20-22, the loan scenario may be saved directly to the borrower profile on the initial inquiry. FIG. 20 is an exemplary screenshot of a display 1501 listing a directory of chat sessions including an icon 1510 for User A. Upon clicking the icon 1510, a loan scenario 1610 is presented as shown in display 1601 in FIG. 21. FIG. 22 is an exemplary screenshot 1710 of a webpage showing an icon 1710 for a user.

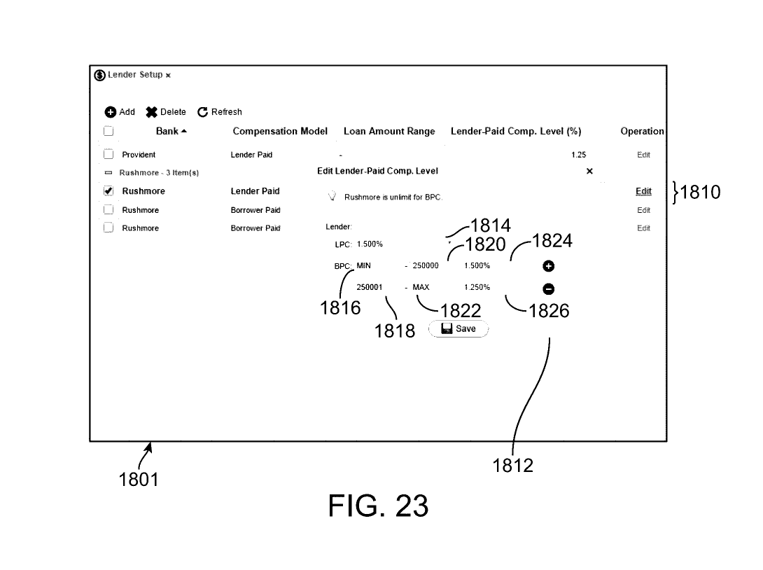

In one or more embodiments, the loan agent 14 may select the lender paid compensation and the borrower paid compensation. FIG. 23 is an exemplary screenshot of a display 1801 illustrating the selection of lender paid compensation and borrower paid compensation. Upon clicking on the “Edit” hyperlink 1810, a pop-up window 1812 appears and presents lending paid compensation 1814, information for borrower paid compensation, including the ranges 1816-1820, 1818-1822, and the corresponding compensation rates 1824 and 1826.

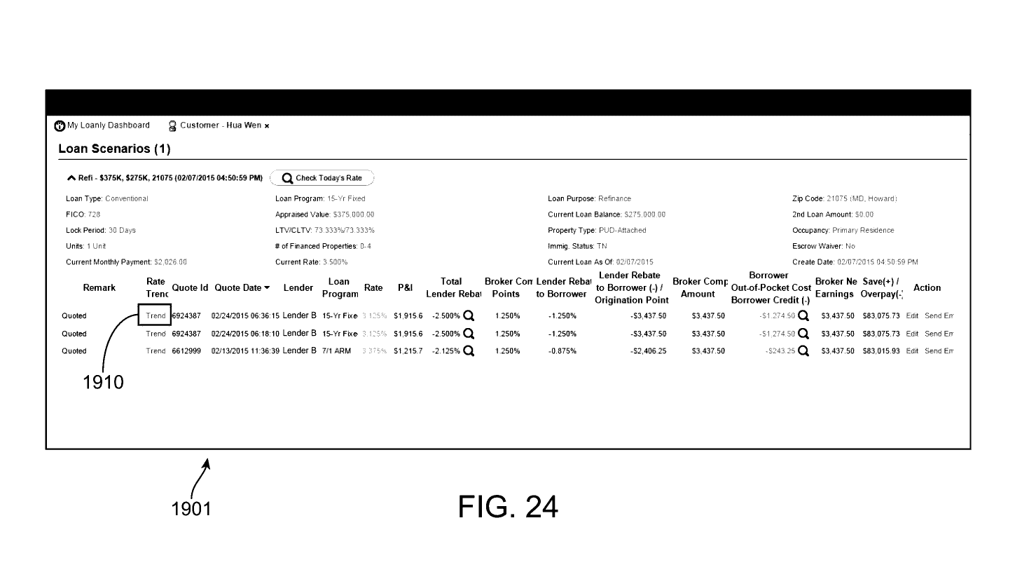

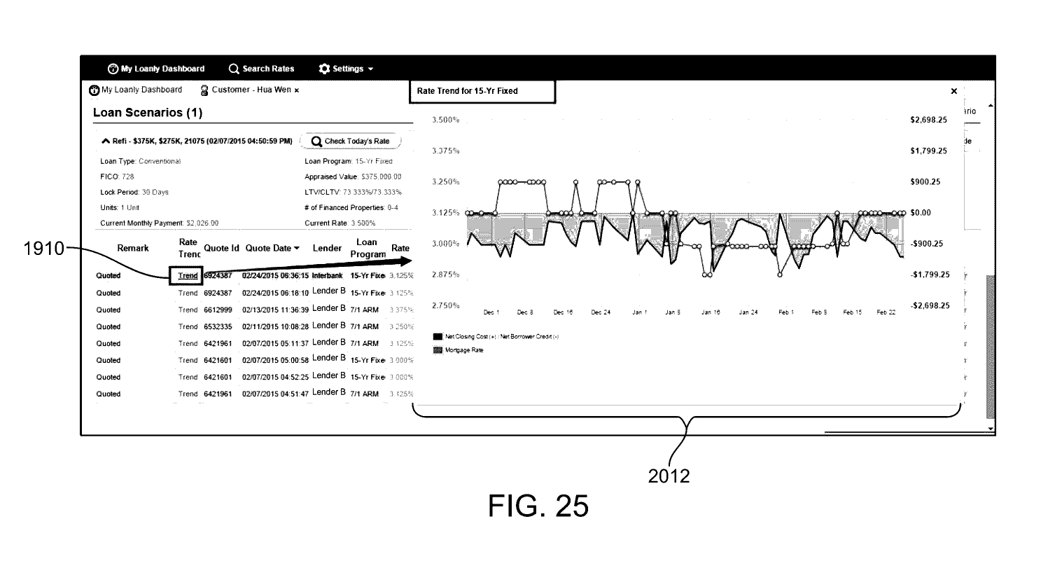

In one or more embodiments, the custom rate trend for a particular loan scenario of a customer may be determined. As shown in FIGS. 24 and 25, a user selects a “Trend” hyperlink 1910 on a display 1901, and a pop-up window 2012 appears which shows the net closing costs and the mortgage rate over a period of time.

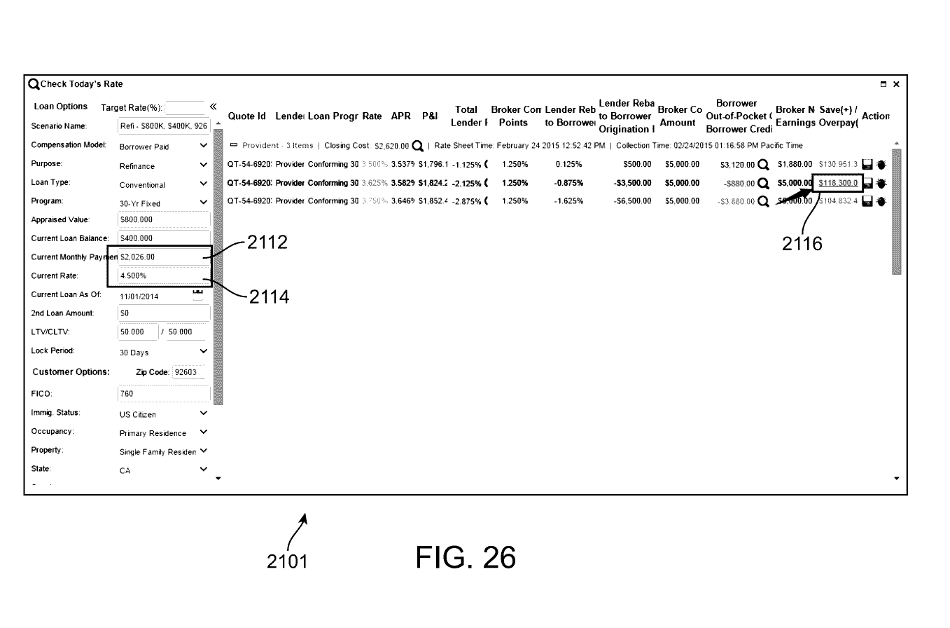

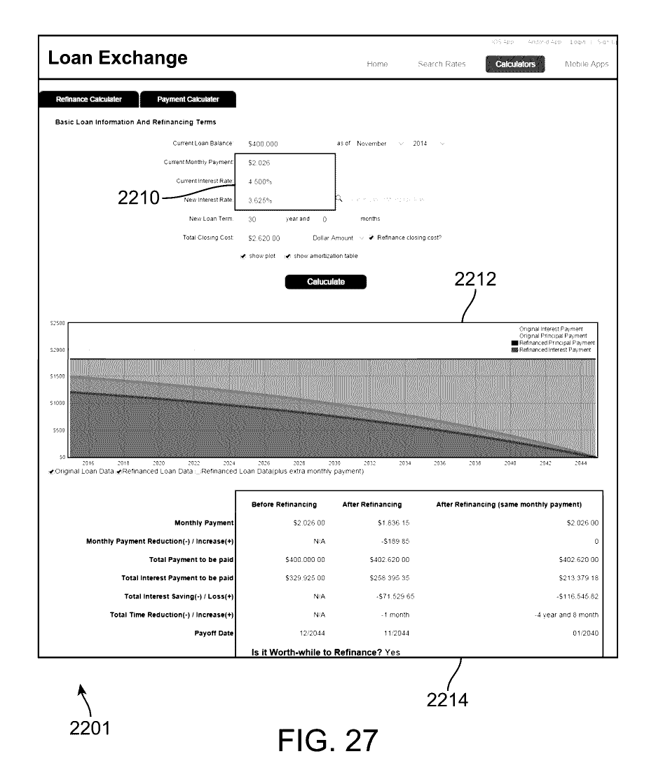

In one or more embodiments, existing loan scenarios may be linked to a refinance calculator. FIGS. 26 and 27 depict screenshots for a loan agent 14 generated by the loan exchange pro app 130. FIG. 26 shows a screenshot of a display 2101 showing entries for the current monthly payment 2112 and the current rate 2114, as well as a hyperlink 2116 for the savings for a specific loan. Clicking on the hyperlink 2116 opens the display 2201 shown in FIG. 27 having loan information 2210, a chart 2212 showing payoff information, and a table 2214 for comparing refinance options.

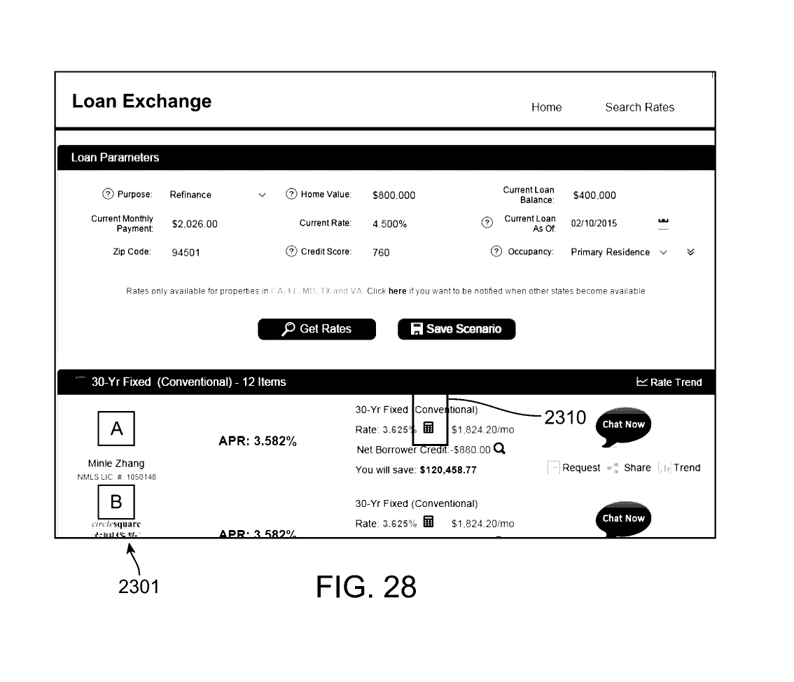

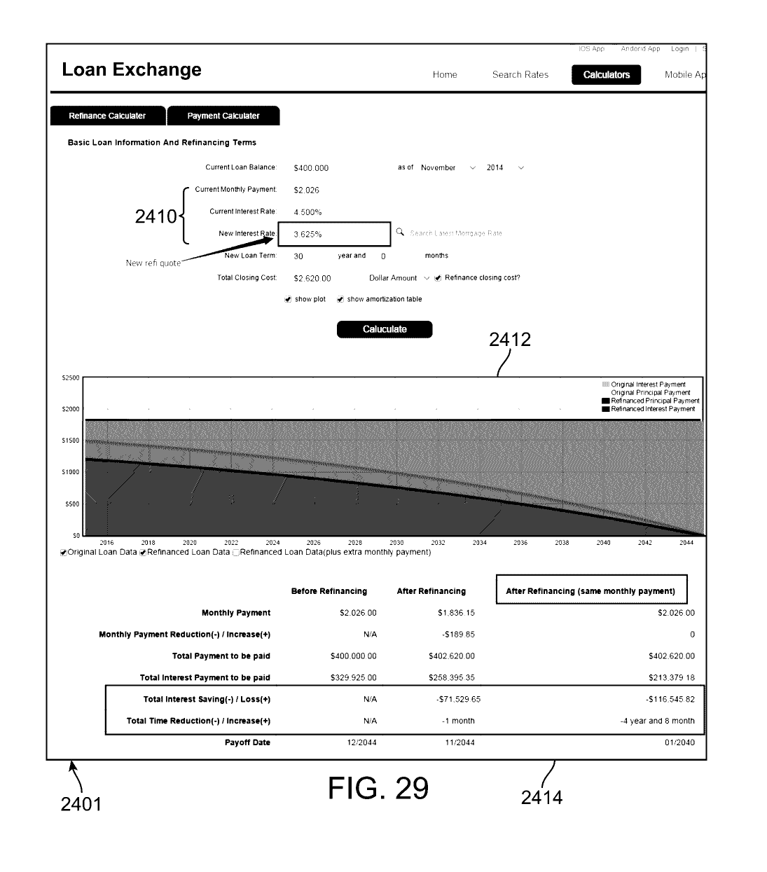

FIGS. 28 and 29 depict screenshots of the refinance calculator for prospective borrowers 10. FIG. 28 is a screenshot of a display 2301 showing a calculator icon 2310. Upon clicking the calculator icon 2310 the display 2401 shown in FIG. 29 having loan information 2410, a chart 2412 showing payoff information, and a table 2414 for comparing refinance options.

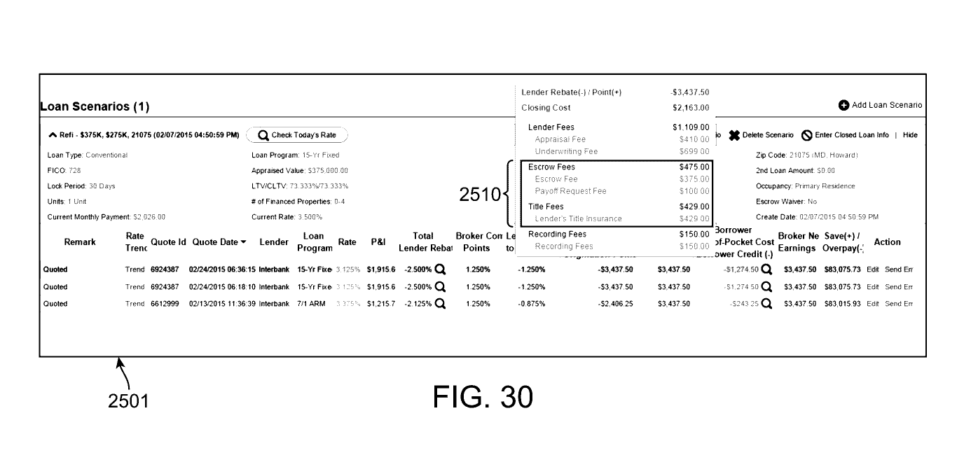

In one or more embodiments, the loan agent 14 may pair a title/escrow fee schedule with rate quotes. As shown in FIG. 30, a quote may include fee information 2510 for both escrow and title agents.

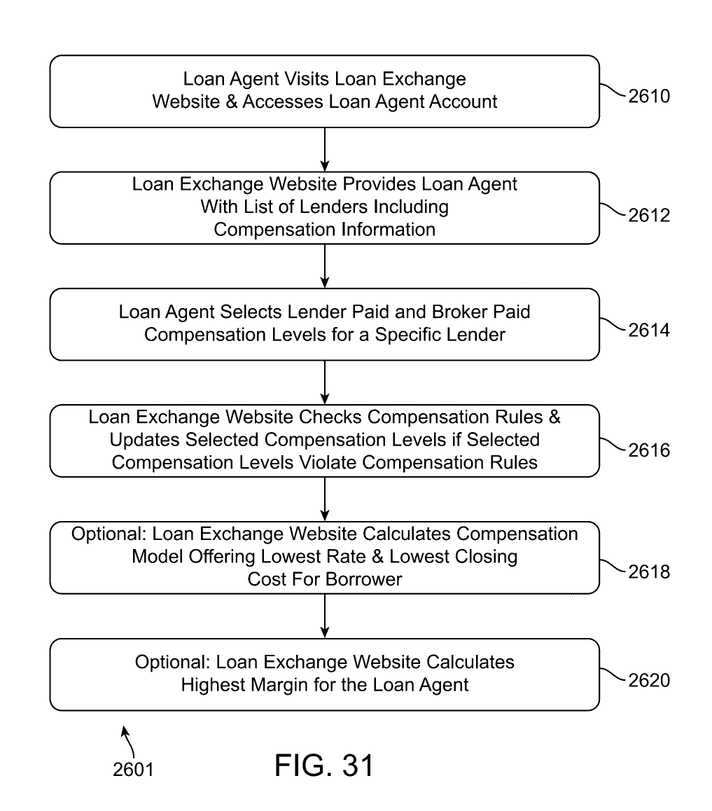

FIG. 31 is a flowchart of the method 2601 for selecting lender paid compensation and borrower paid compensation. In one or more embodiments, the borrower 10, the loan exchange website, the loan agents 14 employ the borrower computing device 122, the loan exchange website device 110, and the loan agent computing devices 128 respectively. The loan agent 14 visits the loan exchange website and accesses the loan agent account (step 2610). The loan exchange website provides loan agent 14 with a list of lenders including compensation information (step 2612). The loan agent 14 selects lender paid and broker paid compensation levels for a specific lender (step 2614). The loan exchange website checks compensation rules and updates selected compensation levels if selected compensation levels violate compensation rules (step 2616). Optionally, the loan exchange website calculates the compensation model offering the lowest rate and lowest closing cost for the borrower 10 (step 2618). Optionally, the loan exchange website calculates the highest margin for the loan agent 14 (step 2620).

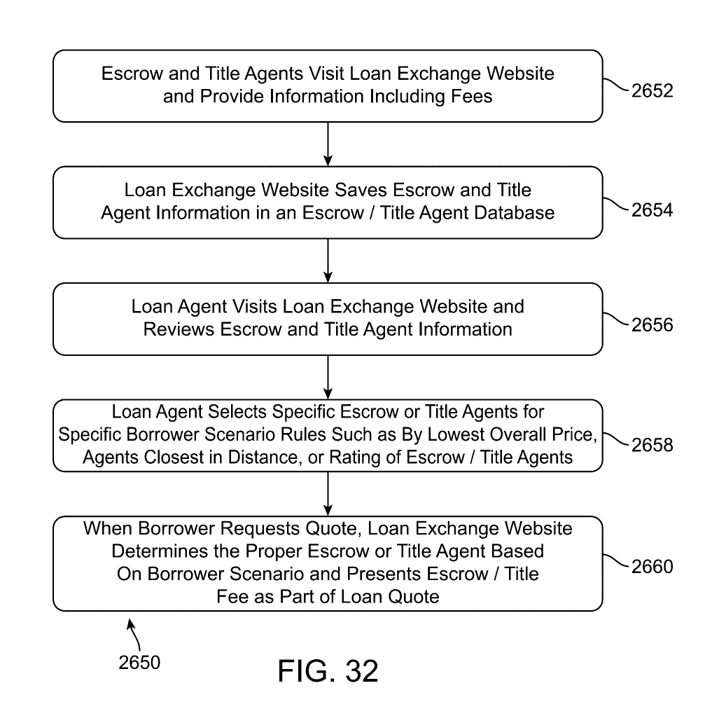

FIG. 32 is a flowchart showing the method 2650 for loan agent selecting specific escrow and title agents. In one or more embodiments, the escrow/title agent 12, the loan exchange website, the loan agents 14 employ the escrow/title computing device 120, the loan exchange website device 110, and the loan agent computing devices 128 respectively. The escrow and/or title agents 12 visit loan exchange website device 110 and provide information including fees (step 2652). The loan exchange website saves escrow and title agent information in an escrow/title agent database 114 (step 2654). The loan agent 14 visits the loan exchange website device 110 and reviews escrow and title agent information (step 2656). The loan agent selects specific escrow or title agents for specific borrower scenario rules, such as by lowest overall price, agents closest in distance or rating of escrow/title agents (step 2658). When the borrower 10 requests a quote, loan exchange website device 110 determines the proper escrow or title agent based on borrower scenario and presents escrow/title fee as part of loan quote (step 2660).

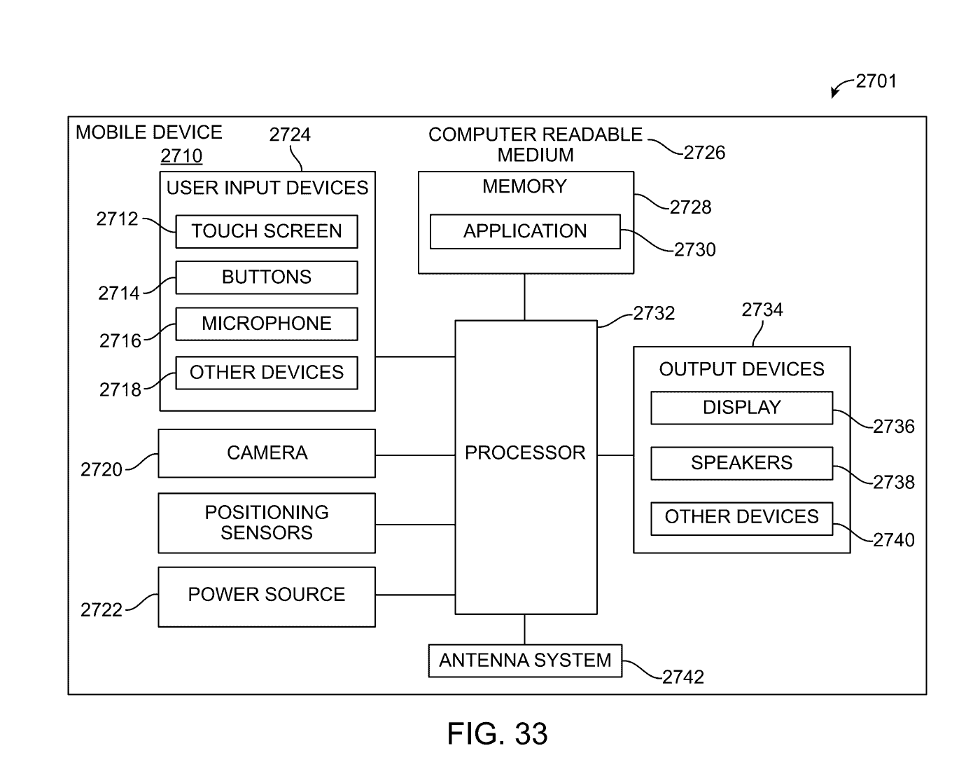

FIG. 33 shows an embodiment of a mobile device 2810. The mobile device has a processor 2832 which controls the mobile device 2810. The various devices in the mobile device 2810 may be coupled by one or more communication buses or signal lines. The processor 2832 may be a general purpose computing device such as a controller or microprocessor for example. In an embodiment, the processor 2832 may be a special purpose computing device such as an Application Specific Integrated Circuit (“ASIC”), a Digital Signal Processor (“DSP”), or a Field Programmable Gate Array (“FPGA”). The mobile device 2810 has a memory 2828 which communicates with the processor 2832. The memory 2828 may have one or more applications such as the application 2830. The memory 2828 may reside in a computer or machine readable non-transitory medium 2826 which, when executed, cause a data processing system or processor 2832 to perform methods described herein.

The mobile device 2810 has a set of user input devices 2824 coupled to the processor 2832, such as a touch screen 2812, one or more buttons 2814, a microphone 2816, and other devices 2818 such as keypads, touch pads, pointing devices, accelerometers, gyroscopes, magnetometers, vibration motors for haptic feedback, or other user input devices coupled to the processor 2832, as well as other input devices such as USB ports, Bluetooth modules, WIFI modules, infrared ports, pointer devices, or thumb wheel devices. The touch screen 2812 and a touch screen controller may detect contact, break, or movement using touch screen technologies such as infrared, resistive, capacitive, surface acoustic wave technologies, as well as proximity sensor arrays for determining points of contact with the touch screen 2812. Reference is made herein to users interacting with mobile devices such as through displays, touch screens, buttons, or tapping of the side of the mobile devices as non-limiting examples. Other devices for a user to interact with a computing device include microphones for accepting voice commands, a rear-facing or front-facing camera for recognizing facial expressions or actions of the user, accelerometers, gyroscopes, magnetometers and/or other devices for detecting motions of the device, and annunciating speakers for tone or sound generation are contemplated in one or more embodiments.

The mobile device 2810 may also have a camera 2820, depth camera, positioning sensors 2821, and a power source 2822. The positioning sensors 2821 may include GPS sensors or proximity sensors for example. The power source 2822 may be a battery such as a rechargeable or non-rechargeable nickel metal hydride or lithium battery for example. The processor 2832 may be coupled to an antenna system 2842 configured to transmit or receive voice, digital signals, and media signals.

The mobile device 2810 may also have output devices 2834 coupled to the processor 2832. The output devices 2834 may include a display 2836, one or more speakers 2838, vibration motors for haptic feedback, and other output devices 2840. The display 2836 may be an LCD display device, or OLED display device. The mobile device may be in the form of hand-held, or head-mounted.

Although the invention has been discussed with reference to specific embodiments, it is apparent and should be understood that the concept can be otherwise embodied to achieve the advantages discussed. The preferred embodiments above have been described primarily as online loan exchanges for facilitating real estate transaction. In this regard, the foregoing description of the online loan exchanges is presented for purposes of illustration and description. In one or more preferred embodiments, the feature of the chat session, with product specifications and/or business offering(s) carried over automatically or manually requested, can be applied to other services or industries where customers would need to provide a number of product specifications in order to get a list of sellers or providers and business offerings or price quotes. Hence, the references made herein to loan exchanges, loan agents, and borrowers may be readily generalized to include many other types of transactions. This feature may be applied to home buyers, where a potential home buyer may enter house searching parameters such as zip code, price range, range of number of bedrooms and bathrooms, range of square feet, and so forth to obtain a list of houses listed for sale and their listing agents. When this potential home buyer contacts the listing agent via such a chat function, the search parameters, not just the address of the selected house listing, and/or the house offering selected by this potential home buyer, will be sent to the listing agent automatically in the chat, automatically or by taking a manual action.

In another example, the consumer may be looking for a car, where the list of parameters may include the make, model, and body style. The purchaser may be shopping for home owner insurance, where the list of parameters may include the location and house type. The transaction involving car insurance may have a list of parameters including location, make, and model. A transaction for life insurance may include a list of parameters of insurance amount and age. A consumer looking for health insurance may have a list of parameters including age and sex. A consumer shopping for credit card offers may have a list of parameters including the credit score range.

Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

Unless specifically stated otherwise, it shall be understood that disclosure employing the terms “processing,” “computing,” “determining,” “calculating,” “receiving images,” “acquiring,” “generating,” “performing” and others refer to a data processing system or other electronic device manipulating or transforming data within the device memories or controllers into other data within the system memories or registers.

One or more embodiments may be implemented in computer software firmware, hardware, digital electronic circuitry, and computer program products which may be one or more modules of computer instructions encoded on a computer readable medium for execution by or to control the operation of a data processing system. The computer readable medium may be a machine readable storage substrate, flash memory, hybrid types of memory, a memory device, a machine readable storage device, random access memory (“RAM”), read-only memory (“ROM”), a magnetic medium such as a hard-drive or floppy disk, an optical medium such as a CD-ROM or a DVR, or in combination for example. A computer readable medium may reside in or within a single computer program product such as a CD, a hard-drive, or computer system, or may reside within different computer program products within a system or network. The computer readable medium can store software programs that are executable by the processor 2832 and may include operating systems, applications, and related program code. The machine readable non-transitory medium storing executable program instructions which, when executed, will cause a data processing system to perform the methods described herein. When applicable, the ordering of the various steps described herein may be changed, combined into composite steps, or separated into sub-steps to provide the features described herein.

Computer programs such as a program, software, software application, code, or script may be written in any computer programming language including conventional technologies, object oriented technologies, interpreted or compiled languages, and can be a module, component, or function. Computer programs may be executed in one or more processors or computer systems.

What is claimed is:

1. A machine implemented method for facilitating business transactions, the method comprising:
receiving business offerings from a business via a business computing device;
storing the business offerings in a database operationally coupled with at least one processor;
retrieving the business offerings from the database;
transmitting the business offerings to a second computing device via a network;
receiving matching rules from the second computing device;
receiving a request for goods or services; and,
selecting a compatible business offering based on the business offerings, the request for goods or services, and the matching rules.

2. The machine implemented method for facilitating business transactions of claim 1, wherein the matching rules requires the selection of the compatible business offering based on a lowest overall price of the business offering.

3. The machine implemented method for facilitating business transactions of claim 1, wherein the matching rules requires the selection of the compatible business offering based on a location of the business.

4. The machine implemented method for facilitating business transactions of claim 1, wherein the matching rules requires the selection of the compatible business offering based on a rating of the business.

5. The machine implemented method for facilitating business transactions of claim 1, further comprising presenting the compatible business offering as part of a quotation.

6. The machine implemented method for facilitating business transactions of claim 1, wherein the business is an escrow agent.

7. The machine implemented method for facilitating business transactions of claim 1, wherein the business is a title agent.

8. The machine implemented method for facilitating business transactions of claim 1, wherein the request for goods or services comprises a request for price quotations and/or business offerings.

9. The machine implemented method for facilitating business transactions of claim 1, wherein the network is the Internet.

10. A machine readable non-transitory medium storing executable program instructions which when executed cause a data processing system to perform a method comprising:
receiving business offerings from a business via a business computing device;
storing the business offerings in a database operationally coupled with at least one processor;
retrieving the business offerings from the database;
transmitting the business offerings to a second computing device via a network;
receiving matching rules from the second computing device;
receiving a request for goods or services; and,
selecting a compatible business offering based on the business offerings, the request for goods or services, and the matching rules.

11. The machine readable non-transitory medium storing executable program instructions which when executed cause the data processing system to perform the method of claim 10, wherein the matching rules requires the selection of the compatible business offering based on a lowest overall price of the business offering.

12. The machine readable non-transitory medium storing executable program instructions which when executed cause the data processing system to perform the method of claim 10, wherein the matching rules requires the selection of the compatible business offering based on a location of the business.

13. The machine readable non-transitory medium storing executable program instructions which when executed cause the data processing system to perform the method of claim 10, wherein the matching rules requires the selection of the compatible business offering based on a rating of the business.

14. The machine readable non-transitory medium storing executable program instructions which when executed cause the data processing system to perform the method of claim 10, further comprising presenting the compatible business offering as part of a quotation.

15. The machine readable non-transitory medium storing executable program instructions which when executed cause the data processing system to perform the method of claim 10, wherein the business is an escrow agent.

16. The machine readable non-transitory medium storing executable program instructions which when executed cause the data processing system to perform the method of claim 10, wherein the business is a title agent.

17. The machine readable non-transitory medium storing executable program instructions which when executed cause the data processing system to perform the method of claim 10, wherein the request for goods or services comprises a request for price quotations and/or business offerings.

18. The machine readable non-transitory medium storing executable program instructions which when executed cause the data processing system to perform the method of claim 10, wherein the network is the Internet.

19. A system for electronically facilitating business transactions, the system comprising:
a business computing device from a business;
a network;
a database;
at least one processor operationally coupled to the database, the at least one processor configured to:
receive business offerings from the business via the business computing device,
store the business offerings in the database
retrieve the business offerings from the database;
transmit the business offerings to a second computing device via a network;
receive matching rules from the second computing device;
receive a request for goods or services; and,
select a compatible business offering based on the business offerings, the request for goods or services, and the matching rules.

20. The system for electronically facilitating business transactions of claim 19, wherein the at least one processor is further configured to present the compatible business offering as part of a quotation.
